(19) United States
(12) Patent Application Publication
(10) Pub. No.: US 2026/0023800 A1
(43) Pub. Date: Jan. 22, 2026

(54) Systems and Methods for Place Search in Augmented Reality

(71) Applicant: Google LLC, Mountain View, CA (US)

(72) Inventors: Ju Yon Lee, Los Gatos, CA (US); Mohamed Suhail Mohamed Yousuf Sait, Burlingame, CA (US); Juan David Hincapie Ramos, Palo Alto, CA (US); Andre Quang Le, San Francisco, CA (US); Seung Yoon Oh, Mountain View, CA (US); Tony Shih, San Mateo, CA (US); Joo Young Joung, San Jose, CA (US); Bicheng Luo, Seattle, WA (US); Ohan Oda, Palo Alto, CA (US); Everi Swara Osofsky, New York, NY (US); Khang Si Le, San Francisco, CA (US); Wenli Zhao, Santa Clara, CA (US); Loran Lamar Briggs, Louisville, CO (US); Nicole Lisa Vanchieri, San Francisco, CA (US)

(21) Appl. No.: 18/996,730

(22) PCT Filed: Dec. 30, 2022
(86) PCT No.: PCT/US2022/054378

§ 371 Date: Jan. 17, 2025

Related U.S. Application Data
(60) Provisional application No. 63/390,240, filed on Jul. 18, 2022.

(51) Int. Cl. G06F 16/9537; G06F 16/29; G06T 19/00

(52) U.S. Cl. CPC G06F 16/9537; G06F 16/29; G06T 19/006

(57) ABSTRACT

The present disclosure provides computer-implemented methods, systems, and devices for enabling search in an augmented reality interface. A computing device generates an interface depicting an AR view including image data of at least a portion of a physical real-world environment for display by the computing device. The computing device displays one or more filter elements within the interface, a respective filter element being associated with a point of interest type. The computing device accesses, from a database of geographic locations, data describing a plurality of points of interest within the physical real-world environment. The computing device receives a selection of one the displayed filter elements. The computing device provides, for display in the AR view, a set of augmented reality elements associated with a set of points of interest, wherein the set of augmented reality elements represents a filter-based set of points of interest associated with the filter element.

### RELATED APPLICATION

The present application is based on, and claims the benefit of, U.S. Provisional Patent Application No. 63/390,240 filed Jul. 18, 2022, which is incorporated by reference herein. Applicant claims priority to and the benefit of this application and incorporates this application herein by reference in its entirety.

### FIELD

The present disclosure relates generally to augmented reality (AR). More particularly, the present disclosure relates to place search within an AR view.

### BACKGROUND

Computing devices (e.g., desktop computers, laptop computers, tablet computers, smartphones, wearable computing devices, and/or the like) are ubiquitous in modern society. They can support communications between their users, provide their users with information about their environments, current events, the world at large, and/or the like. A popular use of such devices is generating and displaying augmented reality (AR) views, for example, of at least a portion of a physical real-world environment (e.g., where one or more of such devices is located, and/or the like). An AR view can be part of an interactive AR experience provided to one or more users of such devices, in which such experience is enhanced by computer-generated information perceptible across one or more sensory modalities of the user(s), and/or the like.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method comprises generating, by a computing system with one or more processors, an interface depicting an augmented reality (AR) view including image data of at least a portion of a physical real-world environment for display by the computing system. The method further comprises displaying, by the computing system, one or more filter elements within the interface, a respective filter element in the one or more filter elements being associated with a point of interest type. The method further comprises accessing, by the computing system from a database of geographic locations, data describing a plurality of points of interest within the portion of the physical real-world environment. The method further comprises receiving, by the computing system, a selection of one the displayed filter elements. The method further comprises providing, by the computing system for display in the AR view, a filter-based set of augmented reality elements associated with a set of points of interest, wherein the filter-based set of augmented reality elements represents a filter-based set of points of interest associated with the selected filter element.

Another example aspect of the present disclosure is directed to a computing device. The computing device comprises one or more processors and a computer-readable memory, wherein the computer-readable memory stores instructions that, when executed by the one or more processors, cause the computing device to perform operations comprising generating an interface depicting an augmented reality (AR) view including image data of at least a portion of a physical real-world environment for display by the computing system. The operations further comprise displaying one or more filter elements within the interface, a respective filter element in the one or more filter elements being associated with a point of interest type. The operations further comprise accessing, from a database of geographic locations, data describing a plurality of points of interest within the portion of the physical real-world environment. The operations further comprise receiving a selection of one the displayed filter elements. The operations further comprise providing. for display in the AR view, a filter-based set of augmented reality elements associated with a set of points of interest, wherein the filter-based set of augmented reality elements represents a filter-based set of points of interest associated with the selected filter element.

Another example aspect of the present disclosure is directed towards a non-transitory computer-readable medium storing instructions that, when executed by one or more computing devices, cause the one or more computing devices to perform operations comprising generating an interface depicting an augmented reality (AR) view including image data of at least a portion of a physical real-world environment for display by the computing system. The operations further comprise displaying one or more filter elements within the interface, a respective filter element in the one or more filter elements being associated with a point of interest type. The operations further comprise accessing, from a database of geographic locations, data describing a plurality of points of interest within the portion of the physical real-world environment. The operations further comprise receiving a selection of one the displayed filter elements. The operations further comprise providing, for display in the AR view, a filter-based set of augmented reality elements associated with a set of points of interest, wherein the filter-based set of augmented reality elements represents a filter-based set of points of interest associated with the selected filter element.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example computing device according to example embodiments of the present disclosure;

FIG. 2 depicts an example client-server environment according to example embodiments of the present disclosure;

FIG. 3 illustrates an example augmented reality user interface in accordance with example embodiments of the present disclosure;

FIG. 4 illustrates an example augmented reality user interface in accordance with example embodiments of the present disclosure;

FIG. 5 illustrates an example augmented reality user interface in accordance with example embodiments of the present disclosure;

FIG. 6 illustrates an example augmented reality user interface in accordance with example embodiments of the present disclosure;

FIG. 7 illustrates an example augmented reality user interface in accordance with example embodiments of the present disclosure;

FIG. 8 illustrates an example augmented reality user interface in accordance with example embodiments of the present disclosure; and

FIG. 9 depicts an example flow diagram for a method of performing filtering and searching elements within an augmented reality view according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed to a system for providing search and filtering systems for presenting information in an augmented reality display. In particular, a computing system comprising one or more computing devices can generate an interface depicting an AR view for display by at least one of the computing device(s). Such a view can be of at least a portion of a physical real-world environment. This interface can be used to present information to a user who is on the go (e.g., traveling through the physical world with their user computing device) in a first-person perspective. For example, a user utilizing one or more of the computing devices can be located near a travel way in an urban environment, and one or more sensors (e.g., cameras, and/or the like) of such computing device(s) can generate data representing a view of at least a portion of the urban environment, and the computing device(s) can generate (e.g., based at least in part on the sensor data, map data associated with a geographic location of the computing device(s), and/or the like) an interface depicting an AR view of at least a portion of the urban environment. For example, a view including imagery of a portion of the urban environment (e.g., generated based at least in part on the sensor data, and/or the like), as well as imagery generated based at least in part on the map data associated with the geographic location (e.g., overlaid, overlapping, located within, and/or the like the imagery of the portion of the urban environment, and/or the like).

The AR view can include, one or more augmented reality elements (AR elements), overlaid on top of the imagery of the urban environments or other real-world locations. These augmented reality elements can include one or more indicators of particular entities in the environment. Entities can include any point of interest within the environment including, but not limited to buildings, landmarks, businesses, and so on. Thus, the AR view can include one or more labels identifying particular points of interest within the environment for the user. In this way, the user can have additional information about their environment presented in the AR view. In some examples, such as dense urban environments, there are more potential points of interest within the AR view than can reasonably be displayed at a single time. This is because the AR view has a limited amount of space to display additional AR elements before the interface becomes difficult to use because of crowding.

In response to this situation, the computing system generating the AR view can identify an initial set of AR elements associated with an initial set of points of interest that can be displayed to a user. The initial set can be selected based on a determination of what points of interest are visible to the user in the AR view. This can be accomplished by analyzing the image data displayed in the AR view to detect store fronts or other visible features associated with particular points of interest. In some examples, if a large number of points of interest are visible, the computing system can use a ranking system in which each point of interest is ranked based on its relevance to the user. The most relevant AR elements can be displayed while other elements with a lower relevance can remain hidden.

In some examples, the AR display can include a plurality of filters elements. The filters elements can be represented by an element in the interface of the augmented reality display. For example, the filter elements can be a selectable button or chip within the display. Each filter element can be associated with a particular type of point of interest. For example, filter elements can be associated with the categories of restaurants, coffee shops, museums, monuments, and so on.

The filter elements can be selected and ordered based on one or more factors. In some examples, the factors can include the number of a specific type of point of interest in the area of the computing device. For example, if there is a plurality of restaurants in an area, one of the filter elements displayed can be restaurants. In some examples, the filter elements that are displayed can be based on the user associated with the computing system. Thus, if a user has previously shown interest in a particular type of point of interest, a filter element can be displayed for that type of point of interest.

In some examples, if a user selects a particular filter element, the interface of the augmented reality view can be updated. For example, the AR view can be altered such that one or more augmented reality elements originally displayed and associated with the initial set of points of interest can be replaced with one or more AR elements associated with the selected filter element. In this way, the specific entities, buildings, or points of interest that were originally referenced or represented by one or more AR elements in the view can be replaced with AR elements that are associated with entities that are associated with the selected filter type.

In some examples, the initial set of augmented reality elements is associated with points of interest or entities that are currently visible in the AR view. For example, the computing system can identify, based on image data captured by a camera, one or more buildings, entities, or points of interest currently in the AR view. For example, if a particular storefront is currently displayed in the AR view, an AR element associated with that storefront can be displayed over or near to the storefront. Once a filter element has been selected, a filter-based set of augmented reality elements can be display. This filter-based set of augmented reality elements can be associated points of interest with a type that matches the selected filter. The filter-based set of augmented reality elements can include points of interest that are currently displayed in the AR view as well as points of interest that match the selected filter type associated with locations but are not currently in the AR view. In some examples, the filter-based set of augmented reality elements can include one or more augmented reality elements that indicate a direction in which the associated entity is located. For example, if the associated entity is to the right of the current view an augmented reality element can be oriented near the right side of the screen with an arrow indicating the direction of the location of the entity.

In another example, the filter-based set of augmented reality elements includes an AR element associated with a point of interest would be visible in the AR view but is occluded by a person, object, or building that is between it and the camera of the computing device. In this example, the AR view can be updated with an indicate of where the point of interest would be within the AR view if it were not occluded. In some examples, the AR elements can have a different appearance depending on whether the point of interest is currently displayed or is occluded (including behind one or more buildings). For example, a first icon can be used for AR elements associated with points of interest that are currently displayed in the AR view and a second icon can be used for AR elements associated with points of interest that are occluded. The second icon can include information informing the user of the direction of the point of interest and the distance from the current position of the computing device. In this way, the user can be notified of the direction and distance to points of interest that match the selected filter but are occluded so as to not be currently visible in the AR view.

In some examples, the AR view can have a certain amount of user interface space in which to display augmented reality interface elements. In some examples, if too many user interface elements are displayed at once the augmented reality elements can occlude other portions of the AR view that are important for the user to see. For example, if augmented reality elements obscure one or more displayed portions of the real world, the utility of the augmented reality view can be reduced. As a result, if more than one augmented reality element is planned to be displayed in the augmented reality interface, the computing system can determine whether the augmented reality elements are within a predetermined threshold distance from each other. If so, one or more augmented reality elements can be grouped together, creating a cluster of points of interest all represented by a single AR element.

In some examples, points of interest can be clustered into a single augmented reality interface based on the type or category of point of interest or entity. For example, a plurality of hotels can be grouped together into a single interface element on the augmented reality display.

The augmented reality view can be presented to a user such that the user can select or interact with portions of the AR view. In some examples, the user can select (e.g., via touch input, mouse input, and so on) a particular feature or building within the AR view. The computing system can, in response to that input, generate information about the selected feature or building for presentation to the user.

The systems and methods of the present disclosure provide a number of technical effects and benefits. As one example, the proposed systems can provide for enabling place searching within an augmented reality system. Enabling a user to filter and search from a plurality of possible augmented reality elements can reduce the number of augmented reality elements displayed at any given time without reducing the effectiveness and usefulness of the augmented reality display. Improving the effectiveness of the augmented reality display can reduce the amount of power used and data stored when displaying an augmented reality display. Reducing the amount of storage needed and energy used reduces the cost of the augmented reality system and improves the user experience. This represents an improvement in the functioning of the device itself.

With reference now to the Figures, example embodiments of the present disclosure will be discussed in further detail.

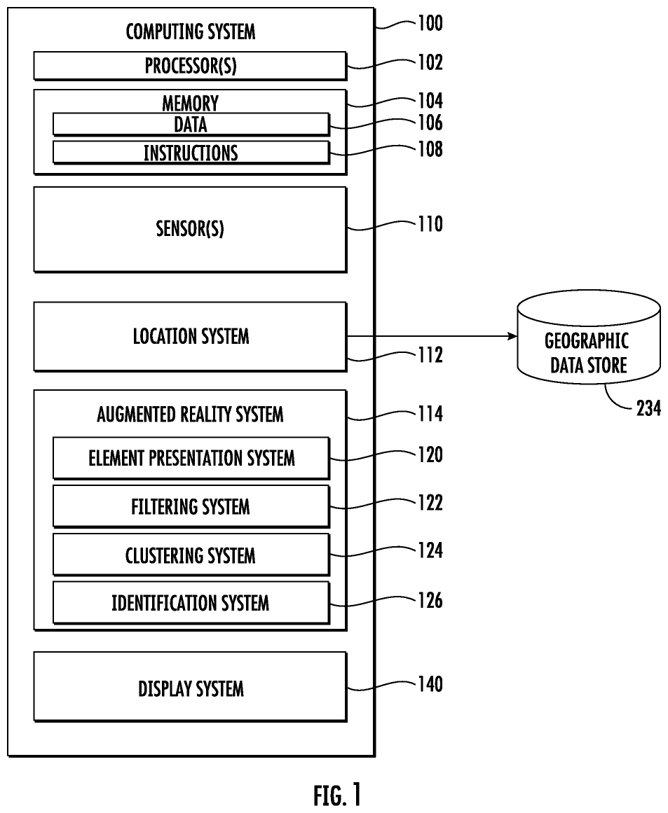

FIG. 1 depicts an example computing device 100 according to example embodiments of the present disclosure. In some example embodiments, the computing device 100 can be any suitable device, including, but not limited to, a smartphone, a tablet, a laptop, a desktop computer, a global positioning system (GPS) device, a computing device integrated into a vehicle, a wearable computing device, or any other computing device that is configured such that it can allow a person to execute an augmented reality application or access an augmented reality service at a server computing system. The computing device 100 can include one or more processor(s) 102, memory 104, one or more sensors 110, a location system 112, an augmented reality system 114, and a display system 140.

The one or more processor(s) 102 can be any suitable processing device, such as a microprocessor, microcontroller, integrated circuit, or other suitable processing devices. The memory 104 can include any suitable computing system or media, including, but not limited to, non-transitory computer-readable media, RAM, ROM, hard drives, flash drives, or other memory devices. Memory 104 can store information accessible by the one or more processor(s) 102, including instructions 108 that can be executed by the one or more processor(s). The instructions can be any set of instructions that when executed by the one or more processor(s) 102, cause the one or more processor(s) 102 to provide the desired functionality.

In particular, in some devices, memory 104 can store instructions for implementing the location system 112, the augmented reality system 114, and the display system 140. The computing device 100 can implement the location system 112, the augmented reality system 114, and the display system 140 to execute aspects of the present disclosure, including presenting an augmented reality display with one or more filters that enable a user to control the augmented reality elements that are displayed in the AR view.

It will be appreciated that the terms “system” or “engine” can refer to specialized hardware, computer logic that executes on a more general processor, or some combination thereof. Thus, a system or engine can be implemented in hardware, application-specific circuits, firmware, and/or software controlling a general-purpose processor. In one embodiment, the systems can be implemented as program code files stored on a storage device, loaded into memory, and executed by a processor or can be provided from computer program products, for example, computer-executable instructions, which are stored in a tangible computer-readable storage medium such as RAM, hard disk, or optical or magnetic media.

Memory 104 can also include data 106, such as map data associated with the location system 112 (e.g., data representing a geographic area including one or more roads and one or more locations of interest received from a server system), that can be retrieved, manipulated, created, or stored by the one or more processor(s) 102. In some example embodiments, such data can be accessed and displayed to a user of the computing device 100 (e.g., during use of a location system 112 or augmented reality system 114) or transmitted to a server computing system as needed.

In some example embodiments, the computing device 100 includes a location system 112, an augmented reality system 114, and a display system 140. The location system 112 can determine the location of the computing device 100 based, at least in part, on data produced by one or more sensors 110. In some examples, the location system 112 can access data in the geographic data store 234. The data stored in the geographic data store 234 can include a description of one or more points of interest (e.g., buildings, monuments, merchants, and so on), the point of interest type, the location of the points of interest, and data used to identify one or more features associated with the point of interest.

In some examples, the location system 112 can be associated with a Global Positioning System (GPS) that provides location system coordinates that determine the location of the computing device 100 using a particular coordinate system. The coordinates provided by the GPS can be used in combination with the information of the geographic data store 234 to identify the specific location of the computing device 100.

The augmented reality system 114 can include an element presentation system 120, a filtering system 122, a clustering system 124, and an identification system 126. The augmented reality system 114 can be a system that displays an AR view to the user via the display of the computing device 100. The AR view can include images of the real physical world overlaid with additional information provided by the augmented reality system 114 that is associated with objects and/or locations pictured in the images of the real physical world. In some examples, the displayed images can represent a live video of a portion of the physical world captured by a camera associated with the computing device 100. In this way, the user can use the camera included in the computing device 100 to capture video of the real physical world and the augmented reality system 114 can augment the live video by overlaying additional information that may be helpful to the user.

For example, the user can direct a camera included in a smartphone to capture video of a line of stores on a street. The smartphone can, using its display, present an AR view including the live video captured of the line of stores. The augmented reality system 114 can overlay (or otherwise combine) the live video with additional visual imagery provided by the augmented reality system 114 itself. This additional visual imagery can include additional information that the user may find helpful. In some examples, the augmented reality system 114 can add elements that include supplemental information to the live video display. The supplemental information can include the name of each store, the type of each store, information about the goods and services provided by the stores, rating information, and so on. This enables a user of the augmented reality system 114 to quickly and easily obtain additional information about their surrounding presented in an easily understood format (e.g., visually displayed near the corresponding physical location or object).

The element presentation system 120 can generate one or more augmented reality elements for display in the AR view. The element presentation system 120 can determine which elements should be shown and determine where the AR elements are to be displayed in the AR view. Each element can include supplemental information for one or more objects, geographic locations, points of interest, or other aspects of the live video displayed in the AR view.

In some examples, an AR element can be a graphical object that can be inserted into the AR view and can represent information associated with a particular portion of the area near the computing device 100. In some examples, the AR element can be a text label overlaid on top of a portion of the AR view giving additional information. For example, displayed entities (including objects, locations, buildings, roads, streets, paths, and so on) can have associated AR elements that notify the user of the name of the corresponding entity. The AR elements can be visually displayed objects in the AR view the user can interact with to access additional information or accomplish a task within the AR view. For example, a merchant store can have an AR element overlaid on it. The AR element can have the name of the merchant store. Selecting the element (e.g., tapping or clicking on it) can result in it increasing in size and providing additional information (e.g., merchant type or hours of operation).

In some examples, the element presentation system 120 can present a plurality of filter elements. Each filter element can be associated with a particular type of point of interest. For example, filter elements can include the name “coffee shops” and thus be associated with merchants that sell coffee. In addition, filter elements can be provided overlaid on the AR view itself or in a navigation section of the AR view located below the live video data.

Once the element presentation system 120 displays one or more filter elements, the user can select that filter element by interacting with the AR view. For example, a user can click on, tap, or otherwise select a particular filter. In response to determining that the user has selected a particular element, the filtering system 122 can display AR elements associated with the selected filter. For example, if the selected filter is “Public Parks” the AR view can be updated to display AR elements associated with any public parks in the view of the live video. In some examples, the AR view can also be updated with an AR element that represents a park that is nearby but is not currently in the AR view.

In some examples, before the filter button is selected element is selected, the AR view can already display an initial set of AR elements. In some examples, the elements that are included in the initial set of AR elements are determined based on the most popular AR elements for the particular location. In another example, the initial set of elements can be selected based on a user's preferences. In some examples, the initial set of AR elements can be determined on a plurality of factors including the time of day, the history of the user, the specific location, and past user input (e.g., AR elements that have more user interactions than other AR elements may be more likely to be displayed in the initial set of AR elements).

In some examples, if the initial set of AR elements is already displayed and the user selects a particular filter button, the filtering system 122 can update the AR view to remove one or more AR elements in the initial set of AR elements and one or more AR elements from a filter-based set of AR elements. For example, the filtering system can remove any AR elements that are not associated with the selected filter element, for example, if the user selects the filter element “Restaurants” the elements can be updated to remove any AR element that is not associated with restaurants.

In other examples, the filtering system 122 can replace the initial set of AR elements with a filter-based set of AR elements. Thus, AR elements that are not associated with the selected filter can be removed and new AR elements that are associated with the selected filter but were not previously displayed can be added to the AR view.

The clustering system 124 can group data from two or more points of interest into a single AR element. The points of interest can be grouped based on their associated point-of-interest type or based on their location within the AR view. For example, if multiple AR elements associated with the same point of interest type are close together, the clustering system 124 can group them into a group and produce a grouped AR element that refers to the point-of-interest type that the AR elements have in common. The user can then select the grouped AR elements, and, in response, the AR view can be updated to display information associated with the points of interest included within the group.

In some examples, AR elements can be grouped based on their position in the AR view. For example, the augmented reality system 114 can determine a maximum density of AR elements for a particular AR view. The maximum density can describe the minimum space or range between different AR elements that is required. If two or more elements are closer than would be allowed by the minimum range, the clustering system 124 can determine whether to combine the AR elements into a cluster. If so, a cluster can be generated and can be represented by an AR element for the entire cluster. In some examples, the clustering system 124 can decide to hide one of the AR elements rather than combine them into a cluster. Deciding whether to hide or cluster AR elements can be determined based on the relative relevance of each element, the type of element, and the preferences of the user.

In some examples, in response to the user-selected filter element, the clustering system 124 can update the clusters into which AR elements are grouped. For example, elements that are associated with the selected filter can be removed from the cluster and displayed separately while elements that are not associated with the selected filter can be hidden or de-emphasized. In some examples, a group of points of interest that are associated with the selected filter, near the location of the computing device 100 (e.g., within a particular threshold), but not included in the current AR view, can be grouped into a cluster and an AR element representing the cluster can be displayed in a portion of the AR view associated with the direction in which the entities or points of interest are located. Thus, if several points of interest associated with the filter are off camera to the right of the current view, an AR element associated with the several points of interest can be generated and displayed on the right portion of the current AR view.

An identification system 126 can receive user input and, in response, identify a particular object or building within the AR view. For example, a user can direct the camera on their device towards a specific object or location in the real world. The camera can capture images of that location and provide those images to the augmented reality system 114. The user can indicate, via input to the computing device 100, that they wish to identify the object, building, or location.

In response to that input, the identification system 126 can, based on location information associated with the computing device 100 and geographic data store 234, determine information about the selected object, building, or location. In some examples, this information can be displayed to the user and the user interface of the AR view. For example, the name of a location can be displayed in the AR element above the selected location.

The geographic data store 234 can store a variety of location or geographic data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings if any are at that location) can be displayed. Similarly, a user can enter the name of a location or point of interest and the system can identify the address associated with that location.

In some examples, the geographic data store 234 can include information that is associated with location determining systems such as the global positioning system (GPS) such that the location of a specific computing device can be determined with respect to the map data. The geographic data store 234 can include data that allows the augmented reality system 114 to determine one or more points of interest within a predetermined distance from the computing device 100.

In some examples, the geographic data store 234 can also include geographic data that is specifically generated for display as part of an augmented reality display. For example, the augmented reality system 114 can generate a plurality of annotations for display in an AR view. In some examples, the annotations can be automatically generated for a particular point of interest based on information stored in the geographic data store 234. In some examples, the annotations can be used for the initial set of augmented reality elements displayed in the AR view prior to the selection of a particular filter element.

In some examples, the geographic data store 234 can also include information allowing the augmented reality system 114 to identify one or more objects, buildings, or locations based on their appearance in the live video data presented by the augmented reality system 114. For example, the geographic data store 234 can include reference images, data describing the appearance of points of interest, and user feedback data that enables the augmented reality system 240 to accurately determine, in a live video, which portions of the live video are associated with which geographic features, objects, building, locations, and so on.

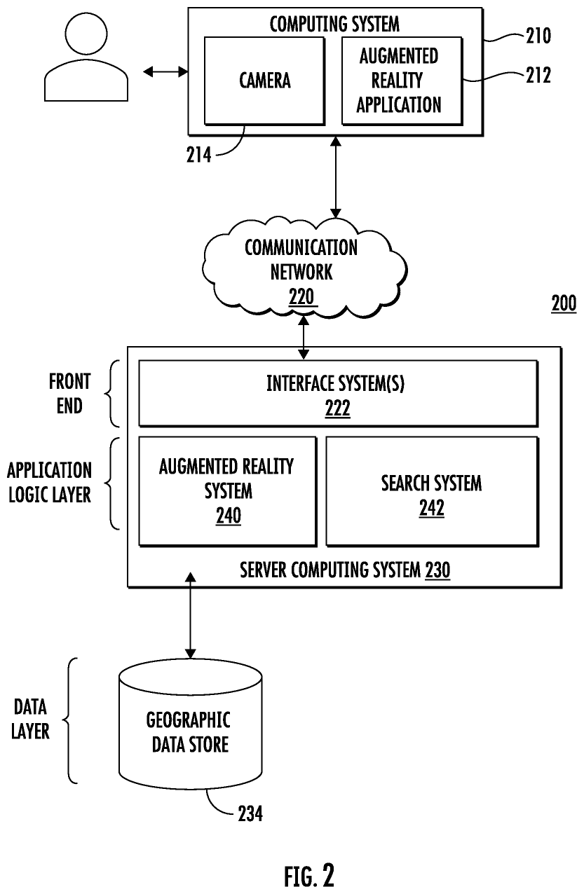

FIG. 2 depicts an example client-server environment 200 according to example embodiments of the present disclosure. The client-server environment 200 includes one or more user computing devices 210 and a server computing system 230. One or more communication networks 220 can interconnect these components. The one or more communication networks 220 may be any of a variety of network types, including local area networks (LANs), wide area networks (WANs), wireless networks, wired networks, the Internet, personal area networks (PANs), or a combination of such networks.

A user computing device 210 can include, but is not limited to, smartphones, smartwatches, fitness bands, navigation computing devices, laptop computers, and embedded computing devices (e.g., computing devices integrated into other objects such as clothing, vehicles, or other objects). In some examples, a user computing device 210 can include one or more sensors intended to gather information with the permission of the user associated with the user computing device 210. For example, the user computing device 210 can include a camera 214.

In some examples, the user computing device 210 can connect to another computing device, such as a personal computer (PC), a laptop, a smartphone, a tablet, a mobile phone, a computing component of a vehicle, or any other computing device capable of communication with the communication network 220. A user computing device 210 can include one or more application(s) such as search applications, communication applications, navigation applications, productivity applications, game applications, word processing applications, augmented reality applications 212, or any other applications. The application(s) can include a web browser. The user computing device 210 can use a web browser (or other application) to send and receive requests to and from the server computing system 230. The application(s) can include an augmented reality application 212 that generates an augmented reality view for display in an interface of the user computing device 210.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more user computing devices 210 and communicates appropriate responses to the user computing devices 210. For example, the interface system(s) 222 may receive requests in the form of Hypertext Transfer Protocol (HTTP) requests, or other web-based, application programming interface (API) requests. The user computing device 210 may execute conventional web browser applications or applications that have been developed for a specific platform to include any of a wide variety of computing devices and operating systems.

As shown in FIG. 2, the data layer can include a geographic data store 234. The geographic data store 234 can store a variety of location data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings if any are at that location). Similarly, a user can enter the name of a location or point of interest and the system can identify the address associated with that location.

In some examples, the geographic data store 234 can include information that is associated with location determining systems such as the global positioning system (GPS) such that the location of a specific computing device can be determined with respect to the map data. The geographic data store 234 can include data that allows the augmented reality system 240 to determine one or more points of interest within a predetermined distance from the user computing device 210.

In some examples, the geographic data store 234 can also include information allowing the augmented reality system 240 to identify one or more points of interest, objects, buildings, or locations based on their appearance in the live video data presented by the augmented reality system 240. For example, the geographic data store 234 can include reference images, data describing the appearance of points of interest, and user feedback data that enables the augmented reality system 240 to accurately determine, in a live video, which portions of the live video are associated with which geographic features, objects, building, locations, and so on.

In some examples, the geographic data store 234 can include location characteristic information about a plurality of points of interest, locations, or entities. As noted above, the location characteristic information can include the address of the location, the geographic position of the location, the type of the location, the type of entity, the hours of operation of the entity, and so on. In some examples, the geographic data store 234 can also include image data, the image data associated with one or more geographic areas. The geographic data store 234 can also include satellite image data associated with one or more geographic areas.

The application logic layer can include application data that can provide a broad range of other applications and services that allow users to access or receive geographic data for use in an AR system or for other purposes. The application logic layer can include an augmented reality system 240 and a search system 242.

The user computing device 210 (e.g., a user computing device such as a smartphone) captures live video data of a portion of the world. The user computing device 210 can transmit to the server computing system 230 information about the user computing device's 210 location and orientation of the camera 214 included in the user computing device 210.

In response to receiving this information from the user computing device 210, the augmented reality system 240 can generate an augmented reality layer to display over top of imagery of the real world. In some examples, the augmented reality layer can include one or more augmented reality elements that are associated with particular points of interest within the real world.

In some examples, the augmented reality system 240 can generate a list of augmented reality elements that should be displayed based on the received location of the user computing device 210 and the orientation of the associated camera 214. In some examples, the list is generated based on the importance or popularity of the points of interest. The augmented reality system 240 can provide one or more filter elements for display in the AR view generated by the augmented reality application 212. Each filter element can be associated with a particular type of point of interest. For example, the filter elements can be based on the categories of restaurants, museums, monuments, historical points of interest, and so on. When a user selects a filter element, the currently displayed set of augmented reality elements can be replaced with a set of augmented reality elements associated with the selected filter.

In some examples, the server computing system 230 prepares a rendered AR layer for presentation at the user computing device 210. In other examples, the augmented reality system 240 provides data (e.g., geographic data, data associated with particular entities, and data describing which AR elements and filter elements to display) to the user computing device 210 and the augmented reality application 212 creates the AR layer.

In some examples, the augmented reality system 240 can access live image data of the physical world and combine it with the augmented reality layer. In this way. the user computing device 210 can display a live video of the real world towards which the camera 214 of the user computing device 210 is directed. The live video can be overlaid with additional interface elements provided by the augmented reality system 240 based on information in the geographic data store 234. As the user computing device 210 moves, and the live images of the physical world change, the augmented reality layer can also be updated to correctly overlay data on top of the corresponding parts of the real world in the AR view.

In some examples, the search system 242 can receive search input or a search query from the user computing device 210 and generate data responsive to the search input or query. For example, the augmented reality system 240 can generate a plurality of filter elements that can be displayed in the AR view (or just below it in the user interface). Each filter element can be associated with one or more point of interest types. If a user selects one of these filter elements, this selection can be interpreted as a user performing a search for that topic. The AR view can be updated to display AR elements associated with the selected filter elements. In some examples, AR elements that are displayed may be removed if they do not match the filter and new AR elements can be shown based on the filter.

In some examples, a user may enter a specific search query into a search field, for example, the search query can be “restaurants near me.” In response, the search system 242 can generate a plurality of query responses based on information in the geographic data store 234. This information can be transmitted to the user computing device 210 for display. In some examples, this can be displayed as a list of locations in a user interface associated with but not containing the AR view. In other examples, each search result can be displayed as one or more elements in the AR view. In some examples, the user can switch between a visual display of the AR elements associated with this search results and a list display of the search results by swiping left or right on the interface associated with the AR view.

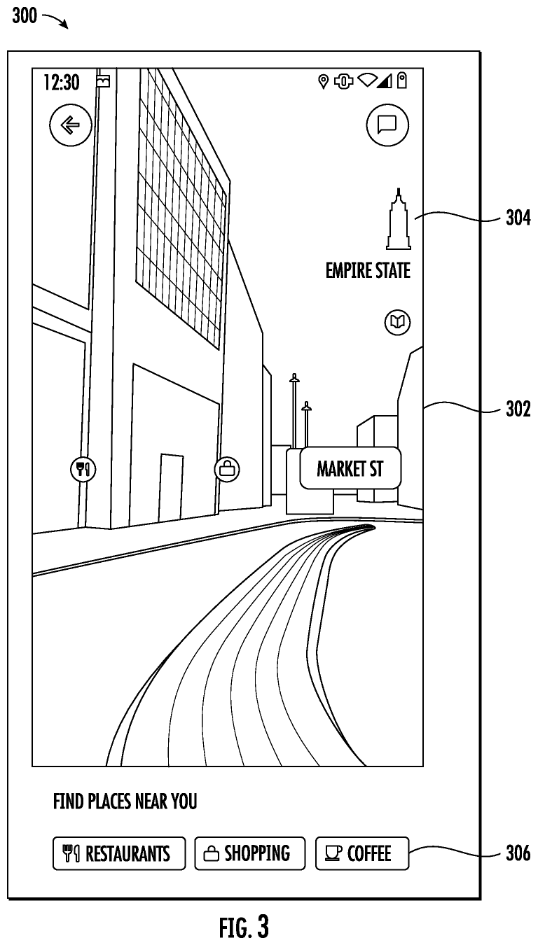

FIG. 3 illustrates an example augmented reality user interface 300 in accordance with example embodiments of the present disclosure. The example interface includes live imagery of the real world in an AR view 302, a plurality of AR elements 304, and a list of one or more filter elements 306.

In this example, the live imagery in the AR view 302 (e.g., live video) includes a video of a street, including a plurality of buildings and other objects. As the user computing device (e.g., user computing device 210 in FIG. 2) moves and changes viewing angle, the live imagery in the AR view 302 can be updated.

In this example, the AR view can include a plurality of AR elements 304. In this example, the AR elements 304 include two elements (a restaurant element and a shopping element), a name label for a street, and interface element providing information about the location of the empire state building. These AR elements provide additional information for the users.

In this example, the one or more filter elements 306 can include a restaurant filter, a shopping filter, and a coffee filter. The example augmented reality user interface 300 shows the filter elements 306 (based on point of interest category) that can be presented for the users to select (e.g., tap on.) The filtering elements (or chips) can be generated based on the nearby POIs to the user. The filters can be ordered based on various factors including, but not limited to: the time of day (e.g., in the morning, a user would be more interested in “coffee” than “shopping”, etc.), the number of nearby POIs in that category, the user's interests, and so on.

Once the user selects a filtering element from the one or more filter elements 306, the augmented reality elements shown in the AR view can be updated to only include AR elements associated with points of interest that are associated with the category of the filter button.

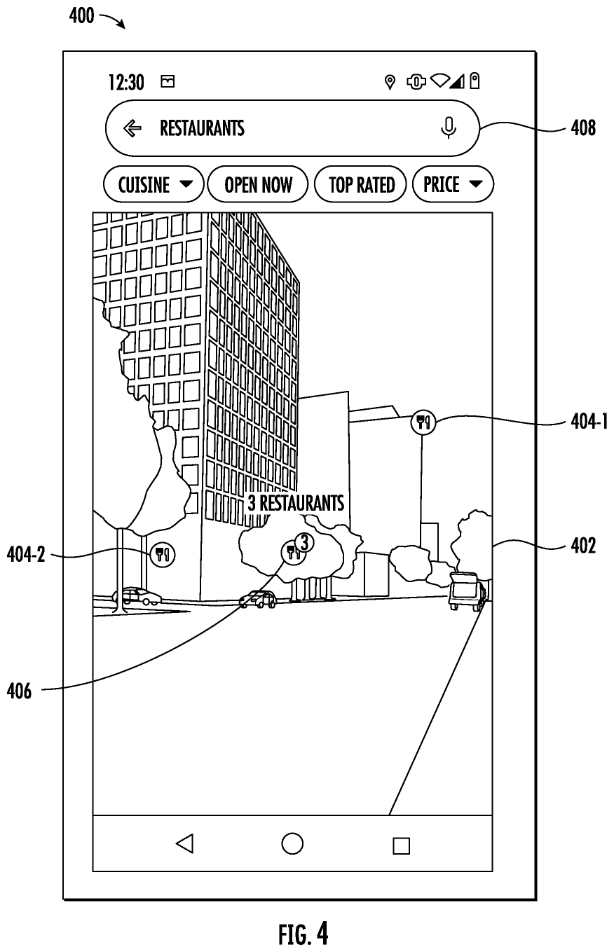

FIG. 4 illustrates an example augmented reality user interface 400 in accordance with example embodiments of the present disclosure. The example interface includes live imagery of the real world in an AR view 402, a plurality of augmented reality interface elements (e.g., 404-1 and 404-2), and a search query field 408. In this example, one of the augmented reality elements is a cluster augmented reality interface element 406. The cluster augmented reality interface element 406 can be associated with a plurality of points of interest (in this case, 3 nearby points of interest with a point of interest type of “restaurant” are clustered together and represented by a single AR element).

In this example, the live imagery included in the AR view 402 (e.g., live video) includes a video of a street, including a plurality of buildings and other objects. As the user computing device (e.g., user computing device 210 in FIG. 2) moves and changes viewing angle, the live imagery in the AR view 402 can be updated.

In this example, the AR view 402 can include a plurality of AR interface elements 404-1 and 404-2. In this example, the AR elements 404 include two elements associated with particular restaurants (both of them are represented by a restaurant icon element (404-1 and 404-2)), a name label for a street, and a cluster augmented reality interface element 406. In some examples, the cluster augmented reality interface element 406 has been generated based on the outcome of a clustering algorithm. The cluster augmented reality interface element 406 can represent three points of interest.

In some examples, the clustering algorithm can be implemented to avoid crowding of results in one section of the AR view 402. Crowding in the AR view 402 can make it difficult for the users to read the information and still see the live video data. In some examples. the points of interest can be clustered based on the proximity within the display (e.g., screen space clustering). For example, the augmented reality system (e.g., augmented reality system 114 in FIG. 1) can determine minimum distance allowable for two AR elements. If two points of interest in the AR view 402 are close enough that their associated AR elements would exceed the minimum distance allowable, the augmented reality system (e.g., augmented reality system 114 in FIG. 1) can cluster them into a group and represent the entire group with a single AR element.

In some examples, the augmented reality system (e.g., augmented reality system 114 in FIG. 1) can determine a minimum distance based on the size of the display (e.g., the number of pixels or the physical size of the display) and the size of the AR elements. Thus, two different displays may result in different clustering of points of interest. Clustering decisions can also be made based on the size of the AR view 402 associated with a point of interest. For example, if four points of interest with a particular type are visible in the AR view 402 but one of them takes up 50 percent of the display and the other three only take up 10 percent of the display, the augmented reality system can cluster the three points of interest into a group while leaving the larger point of interest as a single AR element. In some examples, the AR elements can be resized and have their position shifted to maintain the minimum allowable distance without clustering the points of interest.

Additionally, or alternatively, the points of interest can be clustered based on the type of point of interest. For example, a group of coffee shops can be combined into a group that is represented by a single augmented reality element. In some examples, points of interest can be clustered using both proximity clustering and semantic clustering. When clustering based on screen space, the system can group all the places in a specific region of the screen. For example, the screen space cluster could contain points of interest that are at different distances from the computing device but all fall within the same line of sight to the user. When clustering based on type, the system can use geographical attributes of a place (e.g., a street, a neighborhood, the closeness of the points of interest to a transit stop or popular landmark) to group results. For example, “5 restaurants near Coit tower” or “3 clothing stores on Market Street” are examples of clusters that are defined by their proximity to well-known geographical locations.

In some examples, the methods of clustering can be combined (both screen space clustering and semantic clustering) so that points of interest that are within the AR view can be grouped based on screen space proximity and points of interest that are not within a radius can be grouped using type-based clustering.

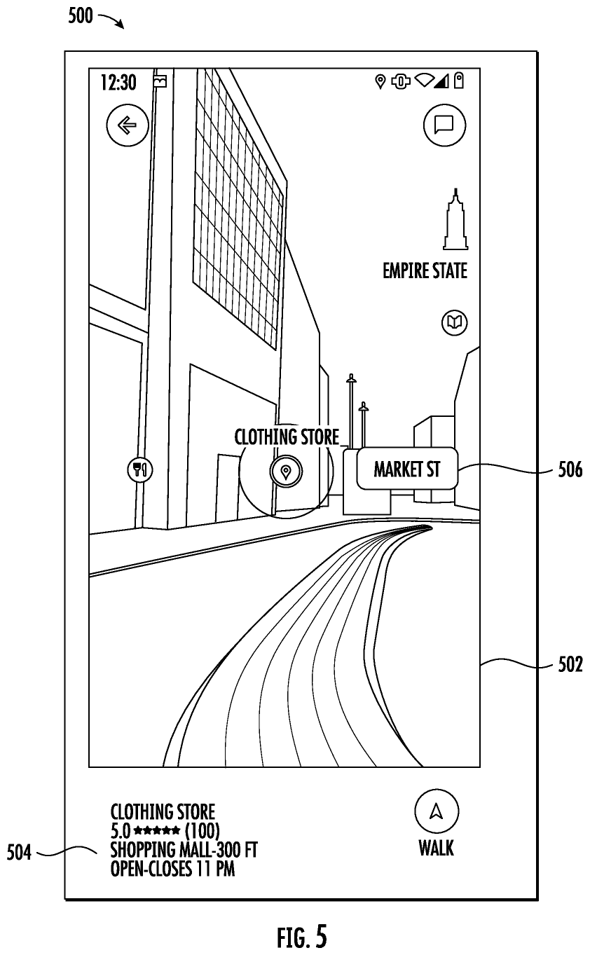

FIG. 5 illustrates an example augmented reality user interface 500 in accordance with example embodiments of the present disclosure. The example interface includes live imagery of the real world in an AR view 502. In this example, the augmented reality system (e.g., augmented reality system 114 in FIG. 1) can enable a user to identify nearby places. To do so in an efficient and query-less way, the user computing device (e.g., user computing device 210 in FIG. 2) can allow the user to select an object or location within the AR view. The augmented reality system (e.g., augmented reality system 114 in FIG. 1) can generate an identification of the selected object or location.

In some examples, the augmented reality system (e.g., augmented reality system 114 in FIG. 1) can generate an identification of the selected object or location based on location information associated with the user computing device (e.g., provided by the user computing device itself), information about the orientation of the camera capturing live video of a geographic location, the imagery displayed at the point selected by the user, and the stored geographic data.

For example, the augmented reality system (e.g., augmented reality system 114 in FIG. 1) can receive user input on a touch screen of the user computing device (e.g., user computing device 210 in FIG. 2) indicating a user request to identify an object or location associated with the location at which the user input was received. In response to this input, the augmented reality system (e.g., augmented reality system 114 in FIG. 1) can determine the current location of the user computing device (e.g., a smartphone). The augmented reality system (e.g., augmented reality system 114 in FIG. 1) can determine, based on sensors within the user computing device, the orientation of the camera that is capturing images of the world.

The augmented reality system (e.g., augmented reality system 114 in FIG. 1) can use the determined location of the device and the orientation of the camera to determine a currently displayed geographic location. The augmented reality system (e.g., augmented reality system 114 in FIG. 1) can access the geographic data associated with the displayed geographic location from the geographic data store 234.

The augmented reality system (e.g., augmented reality system 114 in FIG. 1) can identify a portion of the displayed image that the user has selected or indicated. The augmented reality system (e.g., augmented reality system 114 in FIG. 1) can analyze the image associated with the selected location and compare it with the geographic data retrieved from the geographic data store 234. Based on the analysis of the selected imagery and the data from the geographic data store, the augmented reality system (e.g., augmented reality system 114 in FIG. 1) can identify the particular location or object that the user has selected.

The augmented reality system (e.g., augmented reality system 114 in FIG. 1) can access information about the selected location or object. For example, the augmented reality system (e.g., augmented reality system 114 in FIG. 1) can access the name of the location or object, a category or type associated with the location or object, the information about services and products available, and so on. In some examples, the augmented reality system (e.g., augmented reality system 114 in FIG. 1) can update the augmented reality view to include information about the identified object or location. The information can include an AR element in the AR view. In other examples, the information can include a section of the display dedicated to providing additional information about the selected object or location.

In this example, the user has indicated a location on the display within the augmented reality user interface 500. An indicated location can be marked with an augmented reality interface element 506. The augmented reality system can analyze one or more features of the display video (e.g., one or more live images of a portion of the world) to identify a particular object, location, or point of interest associated with the selected portion of the AR view. In this example, the user selects the facade of a clothing store. The augmented reality system (e.g., augmented reality system 114 in FIG. 1) can determine, based on one or more of the location of the user computing device and the orientation of the camera, the specific entity (e.g., merchant) associated with the selected façade. In some examples, the augmented reality system (e.g., augmented reality system 114 in FIG. 1) can update the AR view to include an AR element 506 that provides additional information for the selected façade (e.g., the name of the associated merchant and a link to additional information).

In some examples, additional information about the selected object, location, or point of interest can be displayed in an information display portion 504 of the user interface below the AR view. In this example, the information display portion 504 includes the name of the selected merchant, review or rating data associated with the merchant, distance information, point-of-interest type information, and hours of access information. In some examples, this information can be provided in another portion of the augmented reality user interface 500.

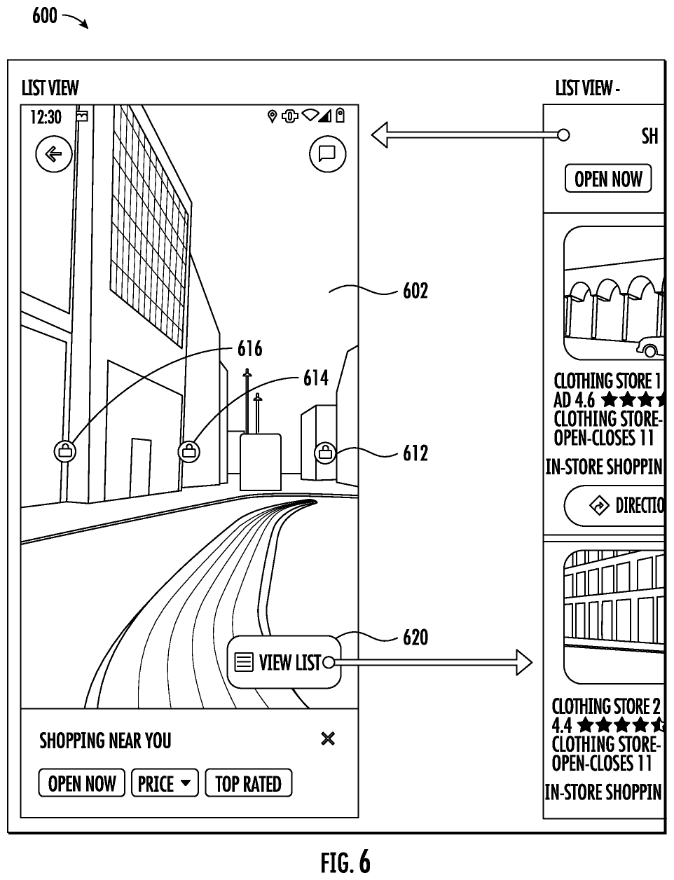

FIG. 6 illustrates an example augmented reality user interface 600 in accordance with example embodiments of the present disclosure. As discussed above, the augmented reality user interface 600 can include an AR view 602. The AR view 602 can include live images (e.g., video) of an area of the world. These images can be captured by a camera associated with the user computing device that is presenting the AR view. These live images can be augmented by additional information supplied by the user computing device (e.g., user computing device 210 in FIG. 2) or a server computing system (e.g., server computing system 230 in FIG. 2) that provides augmented reality systems to the user computing device (e.g., user computing device 210 in FIG. 2) via a communication network.

In some examples, the additional information can be used to present one or more augmented reality elements located in the AR view 602 proximate to the image of a location, object, or point of interest with which the one or more augmented reality elements are associated. For example, if the augmented reality system (e.g., augmented reality system 114 in FIG. 1) determines that a particular merchant (e.g., a store) is within the AR view 602, the augmented reality system can generate an AR element associated with the particular merchant. The generated AR element can be displayed in the AR view 602 over the image of the merchant or nearby the image of the merchant.

In some examples, the AR view 602 can also include a list of filter elements. The filter elements can be used to indicate the types of augmented reality elements the user wishes to see in the AR view 602. The filter elements can each be associated with a particular type of point of interest. When the user selects a particular filter element, the AR view 602 can be updated to include augmented reality elements with a type associated with the selected filter. For example, a user can select a “coffee” filter. In response, the augmented reality system (e.g., augmented reality system 114 in FIG. 1) can update the AR view 602 to include augmented reality elements associated with “coffee” including, but not limited to, coffee shops, cafés, fast food restaurants that serve coffee, and so on. Furthermore, AR elements associated with other topics or point of interest types can be removed, de-emphasized, or hidden.

In some examples, once a user has selected a particular filter element, the augmented reality system (e.g., augmented reality system 114 in FIG. 1) can determine a list of points of interest (e.g., objects, locations, buildings, and so on) within a particular distance from the user computing device. The points of interest in the list of points of interest are associated with the same point of interest type as the selected filter element. In some examples, the user interface can display an interface element that can be associated with a list of associated points of interest. For example, in addition to displaying one or more elements associated with particular points of interest in the list (e.g., 612, 614, and 616), the augmented reality user interface 600 can include a “view list” button 620. The “view list” button 620 can be selected by a user. In response, the augmented reality user interface 600 can be updated to display information associated with the list of points of interest.

In this example, the selected filter element was associated with “shopping.” The generated list of points of interest includes one or more stores. When the view list button 620) is selected, information associated with the one or more stores is displayed by altering the augmented reality user interface 600 to show the list. For example, the list can be displayed on top of the AR view 602, such that the list partially or totally occludes the AR view 602. In another example, the AR view 602 can be temporarily shifted out of the interface and the list of information can be temporarily shifted into the interface. In some examples, the list view can be interactive, ordered by prominence, and allow the user to select a point of interest to see the location in the AR view 602 directly. For example, if a user selects a particular point of interest from the list of points of interest, the AR view 602 can be updated to highlight or otherwise denote the selected point of interest in the AR view 602.

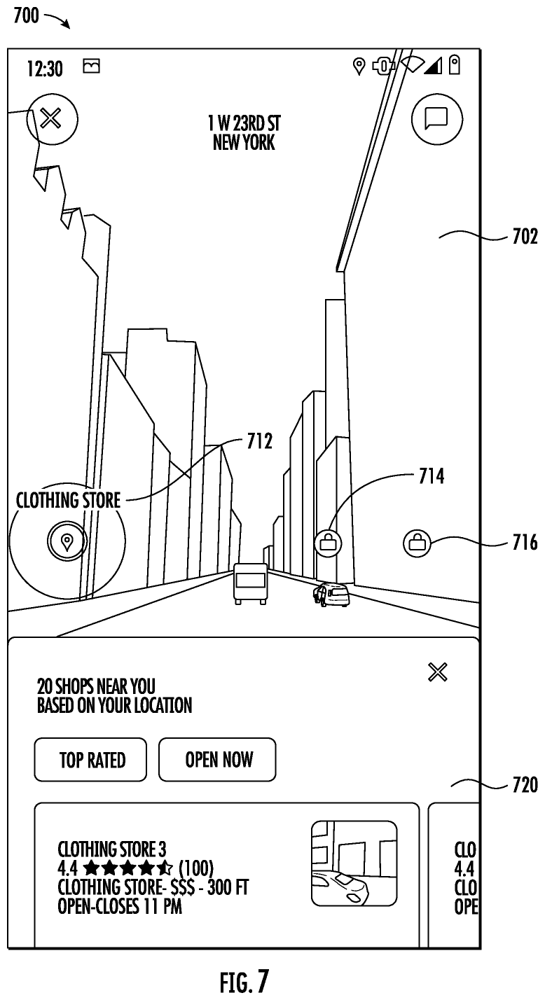

FIG. 7 illustrates an example augmented reality user interface 700 in accordance with example embodiments of the present disclosure. As above, in the description of FIG. 6. a user can select a particular filter element (and thereby select a point of interest type). In response, the augmented reality system (e.g., augmented reality system 114 in FIG. 1) can generate a list of points of interest of that type within a threshold distance of the location of the user computing device. In FIG. 6, the list can be displayed to the user in a different page of the augmented reality user interface 700 when a user selects a “view list” button. FIG. 7 represents an alternative in which the list and the AR view 702 are displayed simultaneously in the same interface. To do so, the list of points of interest can be displayed below the AR view 702 (or partially occluding the bottom of the AR view 702) in a card carousel 720 (e.g., a horizontally scrollable list).

This layout of the augmented reality user interface 700 can have the advantage of allowing a user to fully interact with the augmented reality user interface 700 with only one hand. For example, if a user is holding their smartphone in one hand while the other hand is holding a bag or is otherwise encumbered, the user can still scroll through the card carousel 720 with their thumb.

In some examples, the user can swipe through the card carousel 720 to receive additional information about one or more points of interest. As a user swipes through the card carousel 720 the currently displayed card can be prominently displayed or highlighted. Each card in the card carousel 720 can contain additional supplemental data about the associated point of interest. The supplemental data can include the name of the point of interest, review information, information about the goods and services available at the point of interest (if any), a cost metric associated with the point of interest (e.g., a grouping into a particular cost group), the current distance to the point of interest, hours of operation, and so on.

In some examples, the AR view 702 can be controlled such that the augmented reality element associated with the card currently displayed in the card carousel 720 can be highlighted, allowing the user to identify the specific point of interest within the AR view 702. In the depicted example, the card carousel is currently displaying a card associated with a store called “Brook's Brothers.” The AR element associated with the Brook's Brothers store (AR element 712) is also visually distinguished.

Alternately, users can select a point of interest by directly tapping on the icon in the camera view, in which case the card carousel 720) can scroll to display the card associated with the currently selected point of interest. For example, the user can select one of the points of interest by selecting a displayed AR element (e.g., one of 712, 714, or 716) and the card carousel 720 can be updated to reflect the selected point of interest.

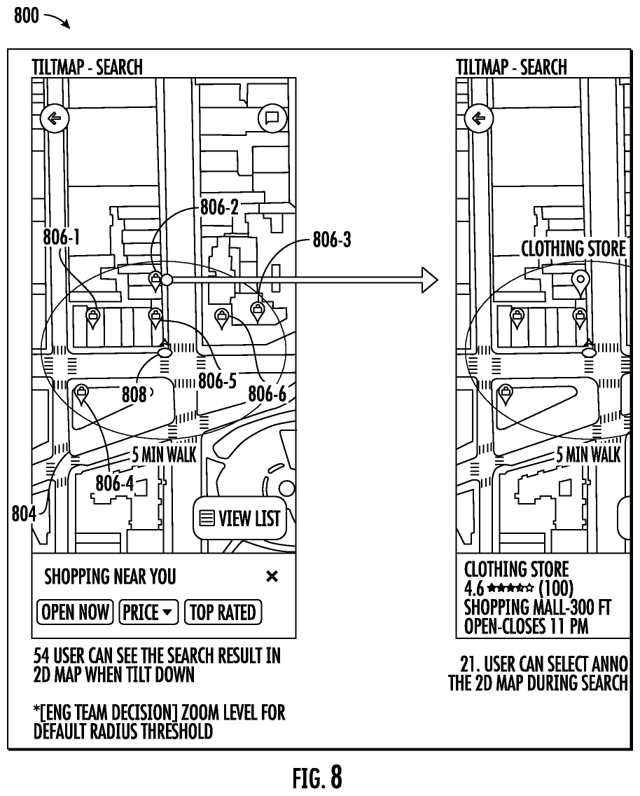

FIG. 8 illustrates an example augmented reality user interface 800 in accordance with example embodiments of the present disclosure. To avoid users getting fatigued with interactions, the augmented reality system (e.g., augmented reality system 114 in FIG. 1) can include an alternative user interface for displaying information about the surroundings of the user. For example, if the user does not wish to hold their user computing device (e.g., user computing device 210 in FIG. 2) up vertically to facilitate capturing video data with a camera integrated into the user computing device, the user can tilt the device down into a more horizontal position. Once the augmented reality system (e.g., augmented reality system 114 in FIG. 12) determines, based on sensors included in the user computing device (e.g., user computing device 210 in FIG. 2), that the tilt of the user computing device (e.g., user computing device 210 in FIG. 2) has exceeded a threshold angle, the augmented reality system (e.g., augmented reality system 114 in FIG. 12) can replace the AR view with a map view 804 of the surroundings of the user computing device (e.g., user computing device 210 in FIG. 2).

In the map view 804, one or more points of interest (e.g., locations, buildings, objects, and so on) can be indicated with a marker element on the map view 804. In some examples, the specific points of interest to be marked in the map view are determined based on the AR elements that were displayed in the AR view before the map view 804 was displayed. For example, if a particular point of interest had an AR element associated with it in the AR view, the augmented reality system (e.g., augmented reality system 114 in FIG. 1) can generate a corresponding marker in the map view.

In this example, a series of markers (806-1 to 806-6) are displayed in the map view 804 at a location associated with the corresponding point of interest. In some examples, the displayed markers represent a list of all the points of interest with a type that match the type of a selected filter element within a predetermined distance from the location of the user computing device. In this example, the user computing device (e.g., user computing device 210 in FIG. 2) is located at marker 808 and line 810 represents a predetermined distance from that location. The predetermined distance can be determined based on the distance that can be traveled in a five-minute walk. Other distances or measures of distance can be used. For example, the predetermined range can be 400 meters. It should be noted that the markers may include points of interest that were not displayed in the AR view when the phone was tilted (because they were out of the view of the camera) but are included in the map view 804 because they match a selected point of interest type (e.g., shopping) and are within the predetermined range (denoted by line 810).

In some examples, a limited list of matching points of interest within the predetermined distance can be displayed. This limited list can be determined by ranking a plurality of matching points of interest based on one or more factors (e.g., user preference, ratings, cost, operating times, the degree to which they match the selected filter element, and so on) and selecting a particular number of points of interest based on the rankings. The particular number of points selected can be determined based, at least in part, on the total number of candidate points of interest and the zoom level at which the map view 804 is currently being viewed. Thus, a user can zoom in to reveal more AR elements associated with points of interest and zoom out to reveal fewer.

In some examples, a user can select one of the markers 806-2 on the map. If the user selects a particular marker, the user interface 800 of the map view can be updated. For example, instead of displaying one or more filtering tools 812 below the map view 804, the user interface 800 can be updated to display information 820 about the point of interest associated with the selected marker 806-2. This information can include the name, rantings, distance, and so on of the point of interest. Enabling the map view to be displayed when the phone is tilted into a horizontal position can enable comfortable browsing of filter results or search results that are consistent with the AR view. Once users finish browsing through the results in a comfortable fashion, they can cause the augmented reality system (e.g., augmented reality system 114 in FIG. 1) to return the interface to the AR view by tilting the user computing device (e.g., user computing device 210 in FIG. 2) back up past the threshold angle. If the user has selected a particular point of interest, an augmented reality element can be prominently displayed in the AR view when it is returned to the display.

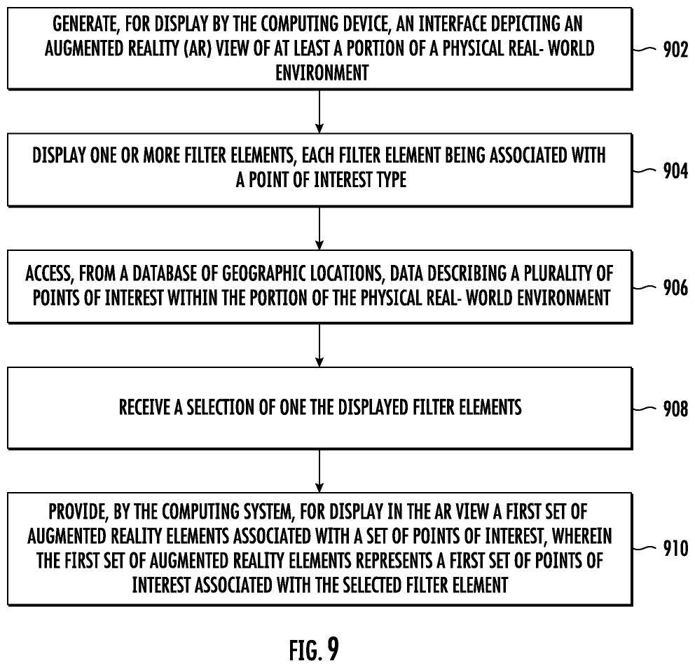

FIG. 9 depicts an example flow diagram for a method for performing filtering and searching elements within an augmented reality view according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-2.

A user computing device (e.g., user computing device 210 in FIG. 2) can include one or more processors, memory, and other components that, together, generate, at 902, for display by the user computing device (e.g., user computing device 210) in FIG. 2), an interface depicting an augmented reality (AR) view of at least a portion of a physical real-world environment. The AR view can therefore include a user interface that has live video imagery displayed. The live video can be captured by a camera that is integrated into the user computing device (e.g., user computing device 210) in FIG. 2). The camera can be a camera integrated into a smartphone. In this way, the video displayed in the AR view represents the current surroundings of a user. The AR view can then augment the live video to display additional information to the user or present entertainment elements that enhance the user's experience of their current environment.

In some examples, the user computing device (e.g., user computing device 210 in FIG. 2) can display, at 904, one or more filter elements, each filter element being associated with a point of interest type. For example, a list of filters can be displayed at the bottom of the interface. The filters in this list can be presented below the live video section of the AR view. In other examples, the list of filters can be displayed as transparent buttons or elements on a portion of the live video in which they will be unobtrusive.

The user computing device (e.g., user computing device 210) in FIG. 2) can access, at 906, from a database of geographic locations, data describing a plurality of points of interest within the portion of the physical real-world environment. In some examples, the user computing device (e.g., user computing device 210 in FIG. 2) can determine its own location. For example, the computing device (e.g., user computing device 210 in FIG. 2) can include a GPS that enables the computing device to determine, with a certain degree of accuracy, the current position of the computing device within the world. This location can be provided to the augmented reality system and used to determine which points of interest to access.

In some examples, the plurality of points of interest within the portion of the physical real-world environment can be within a predetermined distance of the location of the computing device. In some examples, the predetermined distance is based on a walking time from the location of the user computing device (e.g., user computing device 210 in FIG. 2). For example, the predetermined distance can be based on an estimated walking time of five minutes from the location of the computing device. Other estimated walking times can also be used.

In some examples, each point of interest has an associated type (e.g., a point of interest type) and the filter elements are associated with a particular point of interest type. One or more points of interest in the plurality of points of interest are associated with merchants. A point of interest can have multiple types or subtypes associated with it. For example, a specific diner could have a broad type such as “restaurant” associated with it as well as one or more subtypes such as “breakfast food” and “American food.” In addition, related types such as “coffee” can also be associated with the diner. The types can be associated with existing classification systems (e.g., the North American Industry Classification System (NAICS) code, geo concept identifier (GCID) codes, and so on). In some examples, one type can be determined to be a primary type while other types can be determined to be secondary types.

The user computing device (e.g., user computing device 210 in FIG. 2) can display an initial set of augmented reality elements associated with a set of initial points of interest. The initial set of points of interest can be selected based on overall popularity, past user interaction information, a particular user's preferences, the time of day, and so on. The initial set of points of interest displayed for a particular location can be determined such that the most relevant points of interest are highlighted automatically, without specific user request. The initial set of augmented reality elements can be associated with one or more entities currently displayed in the AR view.

The user computing device (e.g., user computing device 210 in FIG. 2) can receive, at 908 a selection of one of the displayed filter elements. For example, if the computing device includes a touch screen, the user can select a particular filter element by touching the screen at a position associated with the desired filter element. The user can select a “coffee” filter element by interacting with the area of the touch screen that contains the “coffee” filter element.

In response to receiving the selection of one of the displayed filter elements, the user computing device (e.g., user computing device 210 in FIG. 2) can update the AR view to remove at least one augmented reality element in the initial set of augmented reality elements. Continuing the above example, if the user selects a “Coffee” filter, the user computing device (e.g., user computing device 210 in FIG. 2) can update the AR by removing one or more augmented reality elements that have point of interest types other than “Coffee.”

The user computing device (e.g., user computing device 210 in FIG. 2) can provide, at 910, for display in the AR view, a filter-based set of augmented reality elements associated with a set of points of interest, wherein the filter-based set of augmented reality elements represents a filter-based set of points of interest associated with the selected filter element. For example, if the user has selected a “Coffee” filter, the AR view can be updated to include augmented reality elements (e.g., visual interface elements such as a label, marker, or button) associated with points of interest that are of the “Coffee” type or are associated with Coffee.

As noted above, one or more initially displayed augmented reality elements can be removed to add the augmented reality elements associated with “coffee” points of interest. In some examples, one or more points of interest in the initial set of points of interest can be included within the filter-based set of points of interest. For example, the initial set of augmented reality elements can include one or more AR elements associated with coffee shops. Then, if the user selects the “coffee” filter element, those AR elements associated with coffee shops will remain, while AR elements associated with other types can be removed and replaced with additional AR elements associated with the selected “Coffee” point of interest type.

A respective AR element in the filter-based set of augmented reality elements can be displayed proximate to the entity with which it is associated in the AR view. For example, if an AR element provides additional information about a store, the AR element can be positioned such that it overlaps a portion of the image of the building in which the store is located. Thus, the AR view can provide information to a user about where a specific point of interest is located, even if the available signage fails to make the location clear.

The user computing device (e.g., user computing device 210 in FIG. 2) can provide AR elements to an AR view by accessing image data from a camera associated with the user computing device (e.g., user computing device 210 in FIG. 2). The user computing device (e.g., user computing device 210 in FIG. 2) can analyze the image data to identify one or more entities within the image data based on storefronts associated with the entities. For example, the user computing device (e.g., user computing device 210 in FIG. 2) can use location information from a user computing device (e.g., a smartphone) to determine the general location of the user. The image data gathered by the camera of the user computing device (e.g., user computing device 210 in FIG. 2) can be analyzed to identify one or more geographic features (e.g., buildings, roads, markings, signs, and so on). The computing device can use information stored in a geographic data store to determine the specific location represented in the image data. Each geographic feature can be matched to one or more entries in the geographic data store (e.g., geographic data store 234 in FIG. 1).

Once the user computing device (e.g., user computing device 210 in FIG. 2) has matched features of the image data (e.g., live video) to a particular geographic entity, the user computing device (e.g., user computing device 210 in FIG. 2) can display, an AR element in the AR view positioned near the feature (e.g., a storefront) associated with a corresponding entity.

In some examples, at least one point of interest in the filter-based set of points of interest may not be displayed within the AR view. For example, once the user has selected the “coffee” filter element, the user computing device (e.g., user computing device 210) in FIG. 2) can identify a plurality of points of interest near the user (e.g., within a threshold distance of the user). Some of these points of interest may be within the threshold distance but not currently displayed in the image data captured by the camera of the user computing device (e.g., user computing device 210 in FIG. 2). For example, the point of interest may be to the right of the live video image data. The AR view can be updated with an AR element that indicates a direction and a distance associated with the point of interest. In this way, the user can be alerted to nearby points of interest that are not currently within the AR view.

In some examples, a particular AR element can be associated with multiple points of interest. In some examples, each point of interest has a point of interest type. The user computing device (e.g., user computing device 210 in FIG. 2) can group multiple points of interest that have the same point of interest type into a group represented by a single AR element. This grouping can occur when the number of points of interest to be displayed is greater than the number that can fit into the AR view. In some examples, all points of interest of a particular type that is currently off-screen can be represented by a single AR element.

In other examples, the user computing device (e.g., user computing device 210 in FIG. 2) can group points of interest into one group based on their respective position in the AR view. For example, the user computing device (e.g., user computing device 210 in FIG. 2) can determine that two or more augmented reality elements are displayed within a predetermined distance in the AR view. In response to determining that two or more augmented reality elements are displayed, the user computing device (e.g., user computing device 210 in FIG. 2) can combine the two or more augmented reality elements into a signal group augmented reality element in the AR view. In this way, the points of interest can be grouped to ensure that the AR view is not crowded with too many AR elements.

In some examples, the user interface of the augmented reality system (e.g., augmented reality system 114 in FIG. 1) can enable the user to select a feature of the image data for identification. For example, the user computing device (e.g., user computing device 210 in FIG. 2) can receive user input indicating a first entity in the AR view. The user computing device (e.g., user computing device 210 in FIG. 2) can analyze the image data displayed in the AR view to extract one or more characteristics of the first entity. The user computing device (e.g., user computing device 210 in FIG. 2) can access, from the database of geographic locations, data identifying a specific location in the database of geographic locations based on one or more characteristics of the first entity.

The above description of FIG. 9 describes that steps of the method as being performed by the user computing device (e.g., user computing device 210 in FIG. 2). However, these method steps may also be performed, in whole or in part, by a server computing system (e.g., server computing system 230 in FIG. 2) remote from the user computing system (e.g., user computing device 210 in FIG. 2). In some examples, the steps can be performed by more than one device.

The technology discussed herein makes reference to sensors, servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of enabling search in an augmented reality interface, the method comprising:
generating, by a computing system with one or more processors, an interface depicting an augmented reality (AR) view including image data of at least a portion of a physical real-world environment for display by the computing system;
displaying, by the computing system, one or more filter elements within the interface, a respective filter element in the one or more filter elements being associated with a point of interest type;
accessing, by the computing system from a database of geographic locations, data describing a plurality of points of interest within the portion of the physical real-world environment;
receiving, by the computing system, a selection of one the displayed filter elements;
and providing, by the computing system for display in the AR view, a filter-based set of augmented reality elements associated with a set of points of interest, wherein the filter-based set of augmented reality elements represents a filter-based set of points of interest associated with the selected displayed filter element.

2. The computer-implemented method of claim 1, wherein a plurality of points of interest in the plurality of points of interest are associated with merchants.

3. The computer-implemented method of claim 1, further comprising, prior to receiving a selection of one of the displayed filter elements:
displaying, by the computing system, an initial set of augmented reality elements associated with an initial set of points of interest; and
in response to receiving the selection of one of the displayed filter elements, updating, by the computing system, the AR view to remove at least one augmented reality element in the initial set of augmented reality elements.

4. The computer-implemented method of claim 3, wherein one or more points of interest in the initial set of points of interest are included within the filter-based set of points of interest.

5. The computer-implemented method of claim 3, wherein the initial set of augmented reality elements are associated with one or more entities currently displayed in the AR view.

6. The computer-implemented method of claim 3, wherein the initial set of augmented reality elements are selected for display based on one or more detected store fronts in image data used to depict at least a portion of a physical real-world environment in the AR view.

7. The computer-implemented method of claim 3, wherein the initial set of augmented reality elements are selected for display based on a visibility determination for one or more points of interest with a predetermined distance from the computing system.

8. The computer-implemented method of claim 1, wherein a respective AR element in the filter-based set of augment reality elements is displayed proximate to a point of interest with which it is associated in the AR view.

9. The computer-implemented method of claim 1, wherein providing, by the computing system, for display in the AR view a filter-based set of augmented reality elements associated with a set of points of interest further comprises:
accessing, by the computing system, image data from a camera associated with the computing system;
analyzing, by the computing system, the image data to identify one or more entities within the image data based on store fronts associated with the entities; and
displaying, by the computing system, an AR element in the AR view positioned near a feature in the image data associated with a corresponding entity.

10. The computer-implemented method of claim 1, further comprising:
determining, by the computing system, a location of the computing system; and wherein the plurality of points of interest within the portion of the physical real-world environment are within a predetermined distance of the location of the computing system.

11. The computer-implemented method of claim 10, wherein the predetermined distance is based on a walking time from the location of the computing system.

12. The computer-implemented method of claim 11, wherein the predetermined distance is based on an estimated walking time of 5 minutes from the location of the computing system.

13. The computer-implemented method of claim 1, wherein at least one point of interest in the filter-based set of points of interest are not displayed within the AR view.

14. The computer-implemented method of claim 1, wherein a displayed AR element is associated with a group including a plurality of points of interest.

15. The computer-implemented method of claim 14, wherein a respective point of interest has an associated point of interest type and the plurality of points of interest included in the group have a common point of interest type.

16. The computer-implemented method of claim 15, further comprising:
determining, by the computing system, that two or more augmented reality elements are displayed within a predetermined distance in the AR view; and
in response to determining that two or more augmented reality elements are displayed, combining the two or more augmented reality elements into a signal group augmented reality element in the AR view.

17. The computer-implemented method of claim 1, further comprising
receiving, by the computing system, user input indicating a first entity in the AR view;
analyzing, by the computing system, the image data displayed in the AR view to extract one or more characteristics of the first entity; and
accessing, by the computing system from the database of geographic locations, data identifying a specific location in the database of geographic locations based on the one or more characteristics of the first entity.

18. A computing device, the computing device comprising:
one or more processors; and
a computer-readable memory, wherein the computer-readable memory stores instructions that, when executed by the one or more processors, cause the computing device to perform operations comprising:
generating an interface depicting an augmented reality (AR) view including image data of at least a portion of a physical real-world environment for display by a computing system;
displaying one or more filter elements within the interface, a respective filter element in the one or more filter elements being associated with a point of interest type;
accessing, from a database of geographic locations, data describing a plurality of points of interest within the portion of the physical real-world environment;
receiving a selection of one the displayed filter elements; and
providing, for display in the AR view, a filter-based set of augmented reality elements associated with a set of points of interest, wherein the filter-based set of augmented reality elements represents a filter-based set of points of interest associated with the selected displayed filter element.

19. A non-transitory computer-readable medium storing instructions that, when executed by one or more computing devices, cause the one or more computing devices to perform operations comprising:
generating an interface depicting an augmented reality (AR) view including image data of at least a portion of a physical real-world environment for display by a computing system;
displaying one or more filter elements within the interface, a respective filter element in the one or more filter elements being associated with a point of interest type;
accessing, from a database of geographic locations, data describing a plurality of points of interest within the portion of the physical real-world environment;
receiving a selection of one the displayed filter elements; and
providing, for display in the AR view, a filter-based set of augmented reality elements associated with a set of points of interest, wherein the filter-based set of augmented reality elements represents a filter-based set of points of interest associated with the selected displayed filter element.

20. The non-transitory computer-readable medium of claim 19, wherein a plurality of points of interest in the plurality of points of interest are associated with merchants.
